(19) United States
(12) Patent Application Publication
(10) Pub. No.: US 2026/0063087 A1
(43) Pub. Date: Mar. 5, 2026

(54) SYSTEM FOR DIAGNOSING COMPONENT FAILURES OF A COMBUSTION ENGINE

(71) Applicant: Caterpillar Inc., Peoria, IL (US)

(72) Inventor: Chad F. Ahmad, Peoria, IL (US)

(73) Assignee: Caterpillar Inc., Peoria, IL (US)

(21) Appl. No.: 18/825,759

(22) Filed: Sep. 5, 2024

(51) Int. Cl. F02D 41/22

(52) U.S. Cl. CPC F02D 41/22; F02D 2041/224

(57) ABSTRACT

A system for diagnosing component failures of a combustion engine may include a pair of temperature sensors arranged on respective left and right exhaust manifolds of a combustion engine, a pair of pressure sensors arranged on respective left and right intake manifolds of the combustion engine, and a computing device in data communication therewith. The computing device may be configured for receiving temperature values and pressure signals and calculating delta temperature values and delta pressure values. The computing device may establish trend lines for the temperature values, the pressure values, the delta temperature values, and the delta pressure values and may compare the trend lines to a plurality of signatures stored on the computer readable storage medium. The computing device may identify a signature of the plurality of signatures that corresponds to the trend lines and classify the time as exhibiting a particular component failure.

### TECHNICAL FIELD

The present application relates generally to combustion engine performance. More particularly, the present application relates to a system and corresponding method for diagnosing combustion engine components failures. Still more particularly, the present application relates to a system and corresponding method for diagnosing turbo charged combustion engine component failures.

### BACKGROUND

Combustion engines and, in particular, turbo charged combustion engine systems, can suffer from components failures. These failures can impact fuel efficiency as well as emission levels exiting the engine. Unfortunately, in some cases, different types of component failures may exhibit performance symptoms that are the same or similar to the symptoms exhibited by failure of other differing components. This can make it difficult to diagnose which component has failed, which can result in extended periods of down time while the failure is investigated. In some cases, in an effort to avoid the extended periods of down time, an operator may continue to run the engine, thus, extending the length of time of operation during sub-optimal fuel efficiency and increased or sub-optimal emission levels.

Great Britain Patent 2,583,337 relates to a method of determining a fault in an engine with exhaust gas recirculation. The method includes determining an actual pressure differential across the exhaust gas recirculation valve, determining a value of a computed reference pressure differential, comparing the actual and computed pressure differentials to determine a pressure differential error, and diagnosing a fault based on the error.

### SUMMARY

In one or more examples, a system for diagnosing component failures of a combustion engine may include a pair of temperature sensors arranged on respective left and right exhaust manifolds of a combustion engine, a pair of pressure sensors arranged on respective left and right intake manifolds of the combustion engine, and a computing device in data communication with the pair of temperature sensors and the pair of pressure sensors. The computing device may include a processor, a computer readable storage medium having computer implemented instructions stored thereon and performable by the processor. The computer implemented instructions may be for receiving, over a period of time, temperature values from the pair of temperature sensors, receiving, over the period of time, pressure signals from the pair of pressure sensors, calculating delta temperature values over the period of time, and calculating delta pressure values over the period of time. The instructions may also be for establishing trend lines for the temperature values, the pressure values, the delta temperature values, and the delta pressure values. The instructions may also be for comparing the trend lines to a plurality of signatures stored on the computer readable storage medium, identifying a signature of the plurality of signatures that corresponds to the trend lines, and classifying the period of time as exhibiting a particular component failure based on the identified signature.

In one or more additional examples, a method of identifying component failures of a combustion engine may include receiving, over a period of time, temperature values from a pair of temperature sensors arranged on respective left and right exhaust manifolds of a combustion engine, receiving, over the period of time, pressure signals from the pair of pressure sensors arranged on respective left and right intake manifolds of the combustion engine, calculating delta temperature values over the period of time, and calculating delta pressure values over the period of time. The method may also include establishing trend lines for the temperature values, the pressure values, the delta temperature values, and the delta pressure values. The method may also include comparing the trend lines to a plurality of signatures stored on the computer readable storage medium identifying a signature of the plurality of signatures that corresponds to the trend lines; and classifying the period of time as exhibiting a particular component failure based on the identified signature.

### BRIEF DESCRIPTION OF THE DRAWINGS

FIG. 1A is a perspective view of a combustion engine, according to one or more examples.

FIG. 1B is a cross-sectional view of the combustion portion thereof.

FIG. 2 is a schematic diagram of an air system of the combustion engine of FIG. 1, according to one or more examples.

FIG. 3 is a schematic diagram of a communication system for use in monitoring, diagnosing, and/or managing the operation of the engine, according to one or more examples.

FIG. 4 is a flow diagram depicting a method of diagnosing component failures in an engine, according to one or more examples.

FIGS. 5A and 5B are diagnostic diagrams based on a difference in pressure and temperature from a left side to a right side, where 5A reflects a leak on the right and 5B reflects a leak on the left, according to one or more examples.

FIGS. 6A and 6B are diagnostic diagrams based on a difference in pressure and temperature from a left side to a right side, where 6A reflects a cold cylinder on the right and a hot cylinder on the left, while 6B reflects a cold cylinder on the left and a hot cylinder on the right, according to one or more examples.

FIG. 7 is a diagnostic diagram showing a step change of a component failure.

FIGS. 8A and 8B are diagnostic diagrams based on a comparison of an exhaust temperature on a left and a right and pressure on a left and a right, respectively, according to one or more examples.

FIGS. 9A and 9B are diagnostic diagrams based on a comparison of an exhaust temperature on a left and a right and pressure on a left and a right, respectively, according to one or more examples.

FIGS. 10A and 10B are diagnostic diagrams based on a comparison of an exhaust temperature on a left and a right and pressure on a left and a right, respectively, according to one or more examples.

### DETAILED DESCRIPTION

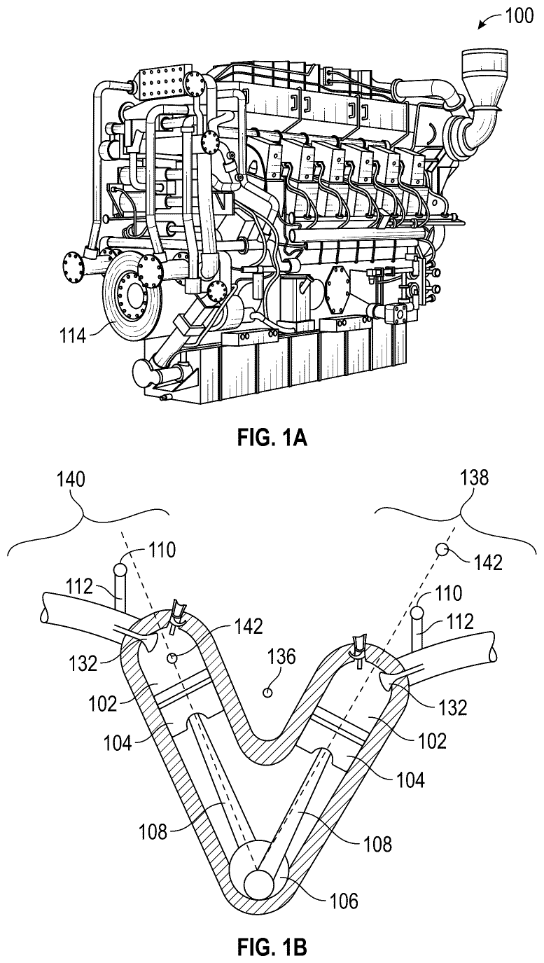

FIG. 1A is a perspective view of a combustion engine 100. As shown in FIG. 1B, the combustion engine 100 may include one or more cylinders 102 with reciprocating pistons 104 arranged therein. The pistons 104 may be connected to a crank shaft 106 via one or more rods 108. The engine 100 may include a fuel manifold 110 that receives fuel from a fuel tank via a fuel pump, for example. The fuel manifold 110 may be arranged and configured to deliver fuel to the cylinders 102 via one or more fuel injectors 112. As discussed in more detail below, the engine 100 may also include an air system 116 that receives air from outside of the engine, delivers air to the cylinders 102 for combustion, treats the air, and exhausts the air back into the environment. The combustion engine 100 may also include an ignition system for delivering a spark to the cylinders 102 to burn the fuel/air mixture received from the fuel manifold 110 and the air system 116, which may drive the pistons 104 to turn the crank shaft 106 and generate rotational power. In one or more examples, the engine 100 may include a power takeoff or fly wheel 114 for coupling to equipment to be mechanically powered. In one or more examples, the equipment to be powered may include waterborne vessels, electrical generators, heavy equipment or work machines, or other systems.

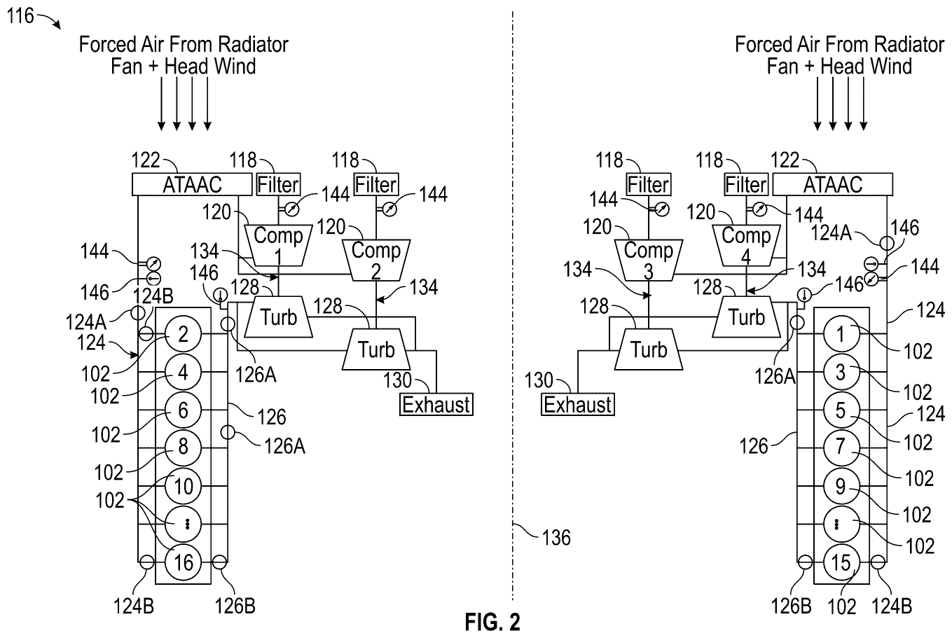

Referring now to FIG. 2, a schematic diagram of the air system 116 is shown. The air system 116 may be configured to collect air from outside the engine 100, filter it, compress it, deliver it to the respective cylinders 102 of the engine 100 to aid combustion, collect the air after combustion, drive turbo chargers with the exhausted air, and release the air back into the atmosphere. In one or more examples, one or more after treatment systems may also be provided to treat the exhaust to reduce emissions. As shown, the air system 116 may include a filter 118, a compressor 120, an air-to-air after cooler 122, an intake manifold 124, an exhaust manifold 126, a turbo charger 128, and an exhaust system 130.

The filter 118 may be configured to remove debris, dust, and other particulate matter from the air as it enters the engine 100 and before it is used for combustion purposes. Depending on the nature of the combustion environment, the filter may include a dust collector for removing larger particulate matter from the air stream before it is directed to filter media. In one or more examples, the filter media may include a material having a relatively low porosity. The filter media may be arranged in one of a variety of shapes and configurations. In one or more examples, the filter media may be in a pleated or corrugated form so as to increase the available surface area for air to pass through the media to help offset the effect of the low porosity on air flow. In one or more examples, an air filter housing may be provided, which may be relatively accessible for purposes of removing and replacing the filter media.

The compressor 120 may include an air compressor adapted to compress the filtered air received from the air filter. The air compressor 120 may be a piston-type air compressor that receives air into a compression chamber as the piston retracts and compresses the air as the piston advances. The compressor 120 may include an inlet in fluid communication with the downstream side of the air filter 118, and an outlet in fluid communication with the air-to-air after cooler 122. The compressor 120 may also include an inlet valve and an outlet valve for controlling the flow of air into and out of the compression chamber. For example, during retraction of the piston, the inlet valve may be open to allow air to flow into the compressor from the air filter and the outlet may be closed. During initial advancement of the piston, both the inlet and the outlet may be closed and at some point during advancement the outlet may open to allow the compressed air to flow downstream of the compressor 120 to the air-to-air after cooler 122.

Air may increase in temperature when it is compressed. The air-to-air after cooler 122 may be configured to cool the compressed air after it is compressed by the compressor 120. The air-to-air after cooler 122 may take the form of a heat exchanger including a coil, fin set, or other fluid routing system that is exposed to a cool air stream such as ambient air around the engine 100. The heat within the compressed air may be released and/or absorbed by the cooler air stream. The rate of this heat exchange may be aided by a relatively large surface area of the coil or fin set. In one or more examples, the air-to-air after cooler 122 may include a fan to advance ambient air across the coils or fin at a higher rate to further assist the rate of heat exchange. In some cases, where the engine 100 is exposed to the elements, head winds due to the movement of the work machine or other equipment movement may also help to advance the ambient or outside air across the coil or fin.

The intake manifold 124 may be configured to deliver the air to the one or more cylinders 102 within the engine 100. As shown in FIG. 2, in one or more examples, the intake manifold 124 may include fluid conduit 124A extending from the air-to-air after cooler 122 to the engine as well as one or more branch lines 124B for delivering the air to particular cylinders. The cylinders 102 of the engine 100 may include valves 132 that operate on a timing system to allow compressed air to enter the combustion chamber of the cylinder 102 when the piston is in a down position, for example. As mentioned above, a fuel manifold 110 with fuel injectors 112 may also be provided. That is, the fuel manifold 110 or fuel rail may support fuel injectors 112 that inject fuel into the compressed air stream before, during, or after it is injected into the cylinder 102. The combination of fuel and air may be ignited by a spark to drive the pistons 104 in reciprocating fashion within the cylinders 102.

Continuing with the air system discussion, after combustion an exhaust manifold 126 may be configured to collect exhaust gas from each of the cylinders 102. The exhaust manifold 126 may include one or more several branch lines 126B each in communication with the combustion chamber of the several engine cylinders 102. The branch lines 124B may lead to a trunk line 124A that collects the exhaust gas and carries it downstream of the engine 100 and to one or more turbo boosters/chargers 128.

The turbo boosters 128 may be configured to leverage the flow of exhaust gas to drive a shaft 134 that assists in driving the air compressor 120. That is, as shown, the turbo boosters 128 may be arranged to receive exhaust gas from the trunk line 126A of the exhaust manifold 126. The turbo booster 128 may include an internal turbine with blades that are driven by the flowing exhaust gas. The flowing gas may drive the turbine, which may connected to a drive shaft 134 coupled with the compressor 120. In this way, some of the energy remaining in the flowing exhaust gas (e.g., energy not utilized to drive the pistons 104) may be returned to the system to drive the air compressor 120.

Downstream of the turbo booster 128, an aftertreatment system may be provided to reduce chemical emissions from the exhaust gas. In one or more examples, and depending on the type of combustion engine being operated (e.g., gas, diesel, etc.), the aftertreatment system may include one or more of a catalytic converter, a diesel particulate filter (DPF), a selective catalytic reduction (SCR) system, or other emission reducing systems.

It is noted, as shown in FIG. 2, that the engine 100 may include a longitudinal axis 136 extending generally parallel to the crankshaft 106 where at least one cylinder 102 is provided on the right side 138 of the longitudinal axis 136 and at least one cylinder 102 is provided on the left side 140 of the longitudinal axis 136. In one or more examples, the cylinders 102 may include longitudinal axes 142 that are generally perpendicular to the longitudinal axis 136 of the engine 100 and the crankshaft 106. In one or more examples, the longitudinal axis 142 of the cylinder 102 (or cylinders) on the right side 138 and the longitudinal axis 142 of the cylinder 102 (or cylinders) on the left side 140 may form a V-shape when viewed along the longitudinal axis 136 of the engine 100 or crankshaft 106.

In any case, and with continued reference to FIG. 2, the cylinder 102 (or cylinders) on the right side 138 may form a right-side bank of cylinders 102 while the cylinders 102 on the left side 140 may form a left-side bank of cylinders 102. An air system such as the one described above may be provided for each bank of cylinders 102. That is, two air systems 116 may be provided where a right-side air system services the right bank of cylinders 102 and a left-side air system 116 services a left bank of cylinders 102.

As shown in FIG. 2, various sensors may be provided to assist with monitoring, diagnosing, and/or managing the operation of the engine 100. In one or more examples, the air system or systems 116 may each include pressure sensors 144 arranged between the air filter 118 and the air compressor 120 as well as at the intake manifold 124. Still further, the air system or systems 116 may each include temperature sensors 146 in the intake manifold 124 as well as at the exhaust manifold 126. In one or more examples, the sensors may capture data including temperature, pressure, or other sensed conditions in and/or around the air systems 116. The data may be in the form of isolated condition values or the sensors may generate an ongoing and/or continuous signal.

In one or more examples, a computing system 148 may be provided to monitor, diagnose, and/or operate the combustion engine 100. In particular, the computing system 148 may be in communication with the one or more sensors arranged on, at, or within the air system or systems 116 to capture data generated by the sensors. In one or more examples, the computing system 148 may include an electronic control module of a work machine or other equipment powered by the combustion engine 100. In some examples, the computing system 148 may be associated with, arranged on, or coupled to the combustion engine 148. In the case of an ECM or other computing device 148 in close proximity to the combustion engine 100, the computing device 148 may be in data communication with the sensors via a wired connection or via close range wireless communications. In other cases, where the computing system 148 is remote from the combustion engine 100, the computing device 148 may be in wireless communication with the sensors where the sensors on the combustion engine 100 may include a transmitter or transceiver 150 for transmitting the sensed data and/or allowing for control of the sensors as well as receipt of data from the sensors.

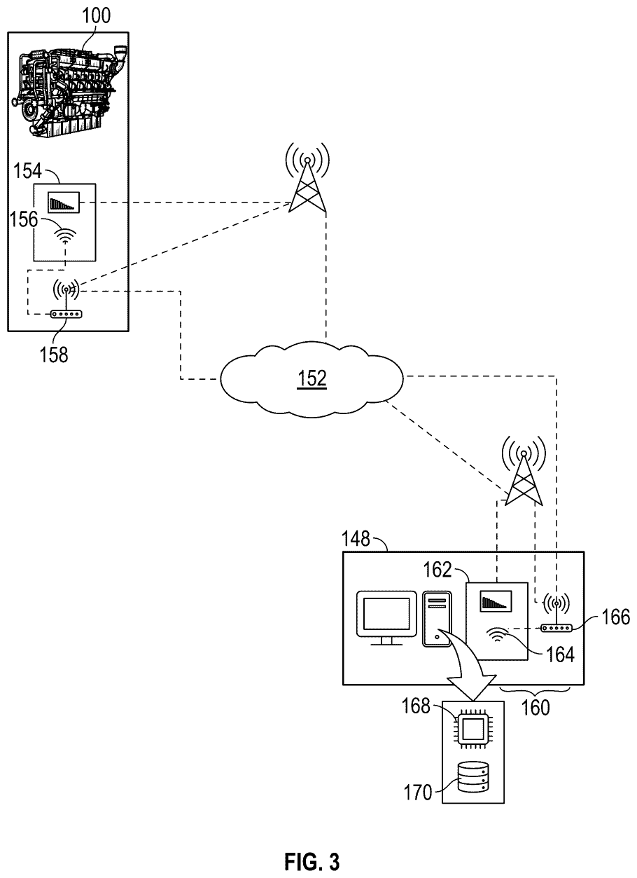

In the case of remote monitoring of the engine performance and with reference to FIG. 3, as mentioned, the combustion engine 100 may include a transmitter or transceiver 150. The transmitter or transceiver 150 may be in wireless communication with a wide area network 152. Such wireless communication may be direct from the transmitter/transceiver 150 such as a cellular connection 154 or via a WiFi connection 156 onboard the equipment or work machine being powered by the combustion engine 100. The WiFi connection 156 may provide for connection to a router 158, which may provide access to the wide area network 152. At the other end of the communication, the computing device 148 may include a receiver or a transceiver 160 so that it may receive data from the sensors of the combustion engine 100 and/or send control and/or operating signals to the combustion engine 100. Like the combustion engine 100, the computing device 148 may be in communication with the wide area network 152 directly such as via a cellular connection 162, or via a WiFi connection/router 164/166 that may provide access to the wide area network 152. It is to be appreciated that while WiFi has been mentioned, other local area network communication protocols may also be provided. Similarly, while cellular has been mentioned, still other wide area network communication protocols may also be used.

The computing device 148 may include one or more inputs, one or more outputs, a processor 168, and a computer readable storage medium 170. In some cases, the one or more inputs may include a keyboard and/or mouse as well as the receiver that receives data from the sensors on the combustion engine directly (e.g., wired) or wirelessly. The computing device 148 may include computer implemented instructions stored within the computer readable storage medium 170. The computer implemented instructions may take the form of hardware, software, or a combination of hardware and software. That is, in one or more examples, the instructions may be in the form of microchips or other hardware components particularly suited for particular tasks and may form a part of the computer readable storage medium 170. In other examples, software may be provided and stored in the computer readable storage medium 170. In still other examples, a combination of the two may be provided.

The computer implemented instructions may be particularly suited for monitoring, diagnosing, and/or managing the operation of the combustion engine 100 and/or the associated work machine or equipment. The computer implemented instructions may be accessible by the processor 168 to perform one or more operations defined by the instructions. In one or more examples, the computer implemented instructions may be particularly adapted for assessing faults, problems, defects, wear, component failures and/or other issues of the combustion engine 100 based on the conditions sensed by the one or more sensors arranged within the air system 116.

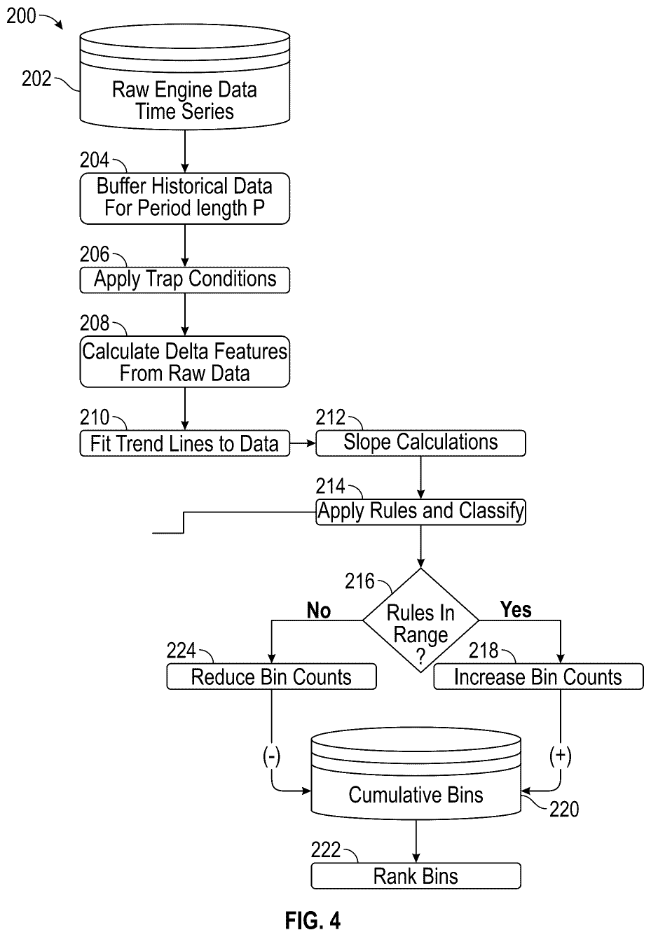

For example, as shown in FIG. 4, a diagram of a process 200 for diagnosing engine issues is provided and the computer implemented instructions for performing the process 200 may be stored on the computer readable storage medium. As shown, the instructions may include processes for receiving 202 raw engine data. For example, signals from the temperature sensors 146 and the pressure sensors 144 may be received by the computing device 148 on an ongoing basis or for selected periods of time. For purposes of analysis, the data may be buffered 204 to focus on a particular period of time. For example, a particular portion of the sensor data series may be focused on such as an hour worth of data, a work shift, a full day, a series of days, a week, a month or other windows of time may be used.

The process may also involve applying trap conditions 206. For example, the temperatures and pressures within the air system may vary depending on the operating conditions of the combustion engine 100. For example, temperatures and pressures may increase at higher revolutions per minute (RPM's) or under higher loading conditions. For purposes of the present analysis, the results may be more useful if the data over time from same or similar operating conditions are used such that changes in the temperature and pressure due to different operating conditions can be removed from the comparison and changes can be more likely related to changes in the component performance of the engine 100. Accordingly, the process may include reviewing the sensor data and selecting data that was taken under particularly selected operating conditions of the engine 100.

As will be described in more detail below, in some cases, the relationship between the left and the right sensors may be relevant in assessing the engine and/or identifying issues such as component failures. As such, the process may include determining the difference 208 between the left-side sensor data and the right-side sensor data. In one or more examples, the values of the right-side sensors may be subtracted from the values of the left-side sensors to establish a delta value. In other examples, the opposite subtraction may be used where the left-side values are subtracted from the right-side values.

Still further, the rate of change of the sensor values and/or the delta values may be helpful in assessing the engine and/or identifying issues such as component failures. Accordingly, the process may include fitting trend lines 210 to the sensor data and/or the delta values. The process may also include calculating the slope 212 of the trend lines over time. For example, as discussed below, the signatures used to identify component failure may include decreasing or increasing trend lines and while temperature and pressure may vary over time, relatively flat slopes may not be sufficient to identify a component failure and the slope calculation may allow for a comparison, not only of whether a value is trending up or down, but how quickly it is trending up or down. In some cases, where slopes of temperature and pressure may be consistent with a particular signature (e.g., trending up and/or trending down), if the slope is not sufficiently significant, the process might not attribute the slope to a component failure.

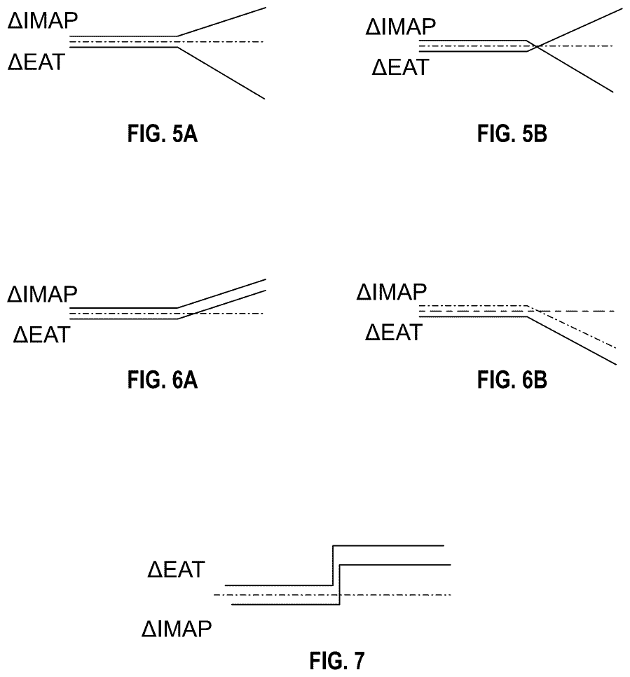

The resulting data may be used to perform an assessment 214 of the component performance of the engine. This may include reviewing the sensor data and/or the delta values over time (i.e., looking at the trend lines). In particular, the assessment may include comparing the trend lines (e.g., data and/or delta values) to known signatures to identify a component failure. The details of this particular portion of the process 200 are discussed in more detail with reference to FIGS. 5A-10B below.

In one example of the process 200, this may be the extent of the process 200. However, in an effort to make the process 200 more statistically accurate, the process may be performed on an ongoing basis and may include a process for accumulating the results of the above-mentioned process to increase the statistical accuracy. For example, where a particular analysis reflects a particular signature 216 (e.g., leak on the left), a count may be tallied in a “leak on left” bin. For example, a count in a database may be increased 218 by one. Where the process is run several times, the count for the “leak on left” bin may be increased each time 220 the result of the process reflects the “leak on left” signature. In some cases, where the process is repeated, other signatures may be reflected by the result such as “leak on right,” “leak on both sides,” “cold cylinder on both sides,” hot cylinder on both sides,” etc. In the end, when the process is repeated, the bin with the most counts may be the most likely to be the bin that correctly identifies the problem. There may be other signatures that have statistically significant counts that also suggest a problem. Accordingly, in one or more examples, the process may include ranking the bins 222 in order where the bin with the highest number of counts is ranked highest and the bins with fewer numbers of counts are ranked lower accordingly. In some cases, a degree of certainty may be provided based on a total bin count as well as the total bin count compared to the other bin counts. For example, a threshold bin count (e.g., 10, 20, or some other threshold) may be used to make sure the problem being identified by the process is repeatable. However, if two signatures each have bin counts of 20, it may remain that the certainty of the diagnosis remains only 50% or both problems could exist. However, where a particular signature has 20 bin counts and the other potential signatures have only 1 or very few, then certainty may be much closer to 90-99% certainty.

While a purely cumulative bin count approach has been described, FIG. 4 also shows an approach that attempts to rule out false positive results. For example, if a first result shows a particular signature, but the next result does not, the process may include reducing the bin count 224 from the bin that accrued a count during the first result. In this way, results that do not show up consistently may be automatically discounted by the process. Still other approaches may involve moving a bin count from a first result to a different bin where the second result shows a different signature. This may be particularly appropriate where the signature of one type of component failure is similar to another and while the first result indicated signature A, the second result strongly indicated signature B and since signatures A and B are similar, it may be likely that the first result was simply slightly off and actually was indicative of signature B. Still other approaches to repeating the process and using the repetition to improve the statistical accuracy of the results may be provided.

### INDUSTRIAL APPLICABILITY

In operation and use, the above-mentioned process 200 may be used to identify component failures. In particular, where these failures tend to exhibit similar symptoms of machine operation, the present process may be suitable to quickly and accurately diagnose the particular component failure allowing for swift repair of the same. That is, while historically, a bad fuel injector or a leak in the air system may both present themselves with poor fuel efficiency and/or poor emissions, these things in and of themselves are not helpful in assessing what the actual problem is. That is, it could be a leak in the air system or it could be a bad fuel injector and it could also be on the left bank or the right bank within the engine.

Using the above-described process, and during the assessment performance step 214, the trend lines of the data may be compared to several signatures identified by the present inventors. For purposes of discussion, it is helpful to understand some of the assumptions the present system makes. First, varying air pressures in the system may result from a variety of things. For example, if there is a leak in the air system 116, the air pressure in the intake manifold 124 may be lower than normal and where the leak size is increasing, the air pressure in the intake manifold 124 may trend downward. However, a fuel injector that is injecting insufficient amounts of fuel may exhibit a similar trend. That is, a fuel injector injecting insufficient amounts of fuel can cause a reduction in the amount of energy exiting the combustion process and, thus, reducing the amount of energy in the exhaust gas that drives the turbo boosters 128. This reduction in turbo power can reduce the amount of pressure generated by the air compressors 120, which may reduce the air pressure in the intake manifold 124. As such, where a fuel injector is failing and continues to inject less and less fuel, the intake manifold air pressure may trend downward. The opposite may also be true where, for example, a fuel injector is injecting excess amounts of fuel. Here the exhaust energy may increase, provide more power to the turbo boosters 1128 and actually increase the pressure in the intake manifold 124. Second, varying temperatures in the system may result from a similar variety of things. For example, if there is a leak in the air system, the amount of air entering the combustion process may be less and, as such, the cooling effect of the air may be less so that the exhaust air temperature increases. As the leak gets worse, the exhaust air temperature may trend upward. The opposite may be true where a fuel injector is injecting insufficient amounts of fuel. The decrease in fuel may reduce the combustion energy and, thus, reduce the heat of the exhaust air. As the injector gets worse and injects less and less fuel, the temperature of the exhaust air may trend downward. Of course, where a fuel injector is injecting excess amounts of fuel, the exhaust air temperature may be hotter and as the injector gets worse, the temperature of the exhaust air may trend upward.

It is noted that given these examples, as has been noted by the inventors, since changes in temperature and pressure can each be attributable to air leaks as well as fuel injector problems, without more, it is difficult to diagnose component failures. That is, an increase in temperature could be due to an air leak, but it could also be due to an injector injecting excess fuel. Decreases in temperature could be due to a fuel injector injecting insufficient fuel. Increases in pressure could be due to a fuel injector injecting excess fuel while decreases in pressure could be due to an air leak or due to a fuel injector injecting insufficient fuel. Using comparisons of right side to left side trend lines, the signatures identified herein may be used in the above-referenced process to better assess component failure.

For example, as shown in FIGS. 5A and 5B, the delta trend lines may help to identify a leak in the air system and also which side the leak is on. That is, FIG. 5A shows the difference between the left and right intake manifold air pressure and the difference between the left and right exhaust air temperature. With an initial focus on pressure, the signature shows that the delta air pressure is trending upward. As we know from the above discussion, increases in pressure can occur from an injector injecting too much fuel, while decreases in pressure can occur from a leak or an injector injecting too little fuel. Moreover, recall that the delta is calculated by subtracting the right from the left. So, an increasing trend could result from a reduction in pressure on the right side (leak or low fuel injection) or an increase in pressure on the left (excess fuel injection). However, the signature also shows that the delta temperature is decreasing. This trend could occur from an increase in temperature on the right (leak or excess fuel injection) or a decrease in temperature on the left (low fuel injection). The failure that is consistent across both delta trends is a leak on the right. FIG. 5B shows the opposite signature where the delta pressure and the delta temperature each reflect a leak on the left.

Turning now to FIGS. 6A and 6B, these signatures may reflect cold/hot cylinders, which in turn may be attributed to a faulty fuel injector. For example, FIG. 6A may be a signature of a faulty injector on the right. With an initial focus on pressure, the signature shows that the delta air pressure is trending upward. The analysis here is the same as FIG. 5A. That is, an increasing trend could result from a reduction in pressure on the right side (leak or low fuel injection) or an increase in pressure on the left (excess fuel injection). However, the signature also shows that the delta temperature is increasing. This trend could occur from a decrease in temperature on the right (low fuel injection) or an increase in temperature on the left (leak or excess fuel injection). Notably, here, there are two failures that are consistent across both delta trends. That is, low fuel injection on the right and excess fuel injection on the left are each potential failures. FIG. 6B shows the opposite signature where the delta pressure and the delta temperature each reflect low fuel injection on the left or excess fuel injection on the right.

FIG. 7 shows that faulty components may exhibit step-type signatures as well. Moreover, while symptoms of components failures may tend to get worse over time and, thus, exhibit trend lines similar to the signatures described in FIGS. 5A, 5B, 6A, and 6B, the symptoms may also get worse and stay constant for a time before getting further worse. In some examples, the trend lines shown in the signatures may include a series of step-type changes in the components of the system.

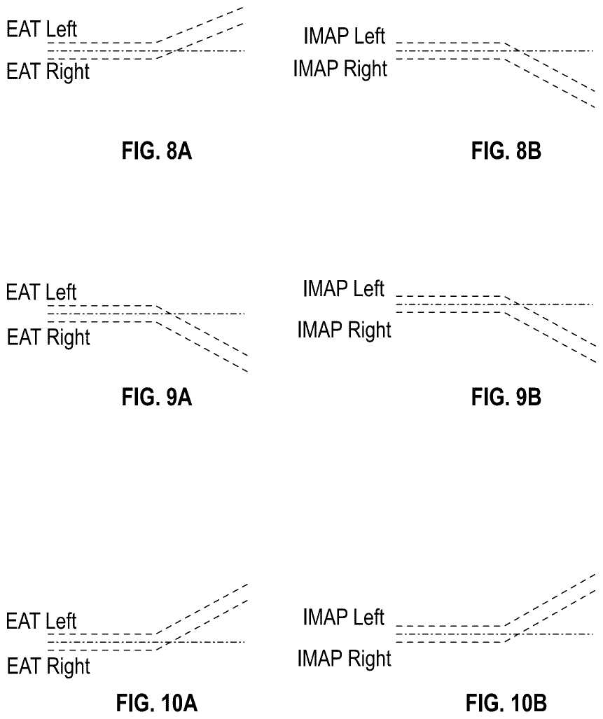

Turning now to FIGS. 8A and 8B, there may be situations where component failures occur on both the right side and the left side. In those, cases, the signatures of FIGS. 5A-6B might not be exhibited because the delta may be relatively constant or just erratic where the component failures are not progressing at a similar rate. In these cases, other signatures that do not rely on the delta may be used. That is, for example, the signature shown in FIG. 8A may reflect a leak on both the left and the right side. That is, the exhaust air temperature on both sides is shown to be increasing. This suggests the cylinder banks on both sides are not getting sufficient air or are, at least, getting continually less and less air such that the exhaust air temperature increases. Alternatively, the fuel injectors on both sides could be injecting increasing amounts of fuel causing the temperature to trend upward. However, the signature of 8B also reflects a leak on both the left and the right side because the intake air manifold pressure on both sides is decreasing. While this could result from injectors on both sides injecting insufficient amounts of fuel, this would cause a reduction in exhaust air temperature not an increase as shown in FIG. 8A. Accordingly, the two signatures used together may suggest a leak on both sides.

Turning now to FIGS. 9A and 9B, a different combination of signatures is shown. Here, FIG. 9A shows that the temperature is decreasing on both sides, which suggests an injector is injecting insufficient amounts of fuel on both sides. Moreover, FIG. 9B, like FIG. 8B, suggests that there is a leak on both sides or an injector on both sides injecting insufficient amounts of fuel. Accordingly, when used in conjunction with FIG. 9A, we can conclude that it is more likely that the problem is a faulty injector on both sides that is injecting insufficient amounts of fuel rather than a leak on both sides like FIGS. 8A/B.

With reference to FIGS. 10A and 10B, these signatures, when used together suggest there is a faulty injector on both sides that is injecting too much fuel. That is, as shown in FIG. 10A, both the left and right-side temperatures are increasing. As we know, this can be the result of a leak on both sides, but it can also be the result of fuel injectors injecting too much fuel and generating excess heat. FIG. 10B shows that the intake manifold pressure on both sides is also increasing. If the problem were a leak on both sides, the intake manifold pressures would be decreasing. So, we can conclude that it is more likely that the fuel injectors on both sides are injecting too much fuel.

These signatures may be used in the assessment performance step of the process above to quickly identify component failures of a combustion engine such that that repairs may be made swiftly and extended use of the equipment during inefficient fuel consumption as well as poor emissions can be avoided.

The above detailed description is intended to be illustrative, and not restrictive. The scope of the disclosure should, therefore, be determined with references to the appended claims, along with the full scope of equivalents to which such claims are entitled.

What is claimed is:

1. A system for diagnosing component failures of a combustion engine, the system comprising:
a pair of temperature sensors arranged on respective left and right exhaust manifolds of a combustion engine;
a pair of pressure sensors arranged on respective left and right intake manifolds of the combustion engine;
a computing device in data communication with the pair of temperature sensors and the pair of pressure sensors and comprising:
a processor;
a computer readable storage medium having computer implemented instructions stored thereon and performable by the processor for:
receiving, over a period of time, temperature values from the pair of temperature sensors;
receiving, over the period of time, pressure signals from the pair of pressure sensors;
calculating delta temperature values over the period of time;
calculating delta pressure values over the period of time;
establishing trend lines for the temperature values, the pressure values, the delta temperature values, and the delta pressure values;
comparing the trend lines to a plurality of signatures stored on the computer readable storage medium;
identifying a signature of the plurality of signatures that corresponds to the trend lines; and
classifying the period of time as exhibiting a particular component failure based on the identified signature.

2. The system of claim 1, wherein the particular component failure is selected from an air leak and a fuel injector failure.

3. The system of claim 2, wherein the air leak is selected from a leak on the left or a leak on the right.

4. The system of claim 2, wherein the fuel injector failure is selected from a fuel injector injecting insufficient amounts of fuel and a fuel injector injecting excess amounts of fuel.

5. The system of claim 1, wherein the plurality of signatures comprises a leak-on-the-right signature where the delta pressure values trend upward and the delta temperature values trend downward.

6. The system of claim 1, wherein the plurality of signatures comprises a leak-on-the-left signature where the delta pressure values trend downward and the delta temperature values trend upward.

7. The system of claim 1, wherein the plurality of signatures comprises a cold-on-the-right/hot-on-the-left signature where the delta pressure values trend upward and the delta temperature values trend upward.

8. The system of claim 1, wherein the plurality of signatures comprises a hot-on-the-right/cold-on-the-left signature where the delta pressure values trend downward and the delta temperature values trend downward.

9. The system of claim 1, wherein the plurality of signatures comprise a leak-on-both-sides signature where the temperature values trend upward and the pressure values trend downward.

10. The system of claim 1, wherein the plurality of signatures comprise a cold-on-on-both-sides signature where the temperature values trend downward and the pressure values trend downward.

11. The system of claim 1, wherein the plurality of signatures comprise a hot-on-on-both-sides signature where the temperature values trend upward and the pressure values trend upward.

12. The system of claim 1, further comprising narrowing the temperature values and the pressure values to values captured during selected operating conditions of the combustion engine.

13. The system of claim 1, further comprising calculating slopes of the trend lines.

14. The system of claim 13, wherein the step of comparing comprises comparing the slopes of the trend lines to slopes of the plurality of signatures.

15. A method of identifying component failures of a combustion engine, the method comprising:
receiving, over a period of time, temperature values from a pair of temperature sensors arranged on respective left and right exhaust manifolds of a combustion engine;
receiving, over the period of time, pressure signals from the pair of pressure sensors arranged on respective left and right intake manifolds of the combustion engine;
calculating delta temperature values over the period of time;
calculating delta pressure values over the period of time;
establishing trend lines for the temperature values, the pressure values, the delta temperature values, and the delta pressure values;
comparing the trend lines to a plurality of signatures stored on the computer readable storage medium;
identifying a signature of the plurality of signatures that corresponds to the trend lines; and
classifying the period of time as exhibiting a particular component failure based on the identified signature.

16. The method of claim 15, further comprising repeating the method multiple times and accumulating counts of the classifying for a plurality of component failures.

17. The method of claim 16, further comprising identifying one of the plurality of component failures as the most likely component failure.

18. The method of claim 17, further comprising calculating a degree of certainty of that the one of the plurality of component failures has occurred.

19. The method of claim 16, further comprising reducing counts of the classifying when the particular component failure is not identified.

20. The method of claim 15, wherein the plurality of signatures comprises a leak-on-the-right signature where the delta pressure values trend upward and the delta temperature values trend downward.
